(19) United States
(12) Patent Application Publication
(10) Pub. No.: US 2024/0386056 A1
(43) Pub. Date: Nov. 21, 2024

(54) TRACKING SYSTEM FOR MOVING BODY

(71) Applicant: TOYOTA JIDOSHA KABUSHIKI KAISHA, Aichi-ken (JP)

(72) Inventors: Naoya YOSHIMURA, Sumida-ku (JP); Hitoshi KAMADA, Setagaya-ku (JP); Hsuan-Kung YANG, Sumida-ku (JP); Norimasa KOBORI, Nakano-ku (JP); Quan KONG, Toshima-ku (JP)

(21) Appl. No.: 18/652,768

(22) Filed: May 1, 2024

(30) Foreign Application Priority Data
May 19, 2023 (JP) 2023-083396

(51) Int. Cl. G06F 16/901; G06F 16/432; G06V 10/40

(52) U.S. Cl. CPC G06F 16/9024; G06F 16/434; G06V 10/40

(57) ABSTRACT

Processing to generate a graph and processing to search for a tracking target by referring the graph are performed. In the processing to search for the tracking target, the feature quantity of the tracking target is extracted from the image of the tracking target. Also, a moving body having the feature quantity that is most similar to the tracking target feature quantity is specified from the moving body feature quantities extracted from at least two moving body images represented by at least two nodes constituting the graph. Then a tracking target graph including a node representing a tracking identification number assigned to the identified moving body and at least one node connected to the node representing the tracking identification number via at least one edge is specified.

### CROSS-REFERENCE TO RELATED APPLICATION

The present application claims priority under 35 U.S.C. § 119 to Japanese Patent Application No. 2023-083396, filed on May 19, 2023, the contents of which application are incorporated herein by reference in their entirety.

### TECHNICAL FIELD

The present disclosure relates to a system that uses image data acquired by a plurality of cameras to track a moving body reflected in this image data.

### BACKGROUND

WO2022185521A discloses an art to search a movement path of a person photographed by a plurality of cameras. In the related art, a person in image data captured by a certain camera is detected, and then a feature quantity of the detected person is extracted. This feature quantity information is registered in a database by combining the time when the detected person was photographed and ID number of the camera that photographed the detected person.

When searching for a movement path, in addition to the feature quantity of the person to be searched, a search range (area and time) is set. In this set search range, a similarity between the feature quantity of the person to be searched and the feature quantity of the person registered in the database is calculated. A person with similarity equal to or greater than a threshold is likely to be the person to be searched. When searching for the movement path, information on the time when such a person was photographed and information on a position of the camera that took the photograph are output as search results.

The related art search also retrieves at least some elements of the search result and arrange them in chronological order to generate movement path candidates. In the related art search, a cost of moving between cameras is further calculated from a graph showing the positions of the plurality of cameras and a positional relationship of these cameras. When the searching for the movement path, this movement cost is used to evaluate candidates for the movement path. If a movement path candidate matching the movement cost is found, this candidate is determined as the movement path of the person to be searched.

In addition to WO2022185521A, WO2014132841A and WO2014045843A can be cited as documents showing the technical level of the technical field related to the present disclosure.

Consider a case to track a moving body (a person, a robot, a vehicle, etc.) reflected in this image data using the image data acquired by the plurality of cameras. In the search technique described in WO2022185521A, the calculation of the similarity with the feature quantity of the person to be searched is performed for all persons in the set search range. Therefore, if the similarity threshold is low, the number of search results output increases, making it difficult to generate the movement path candidates. In this regard, if the similarity threshold is set high, the number of search result outputs can be reduced. However, in this case, if an appearance of the person to be searched changes, such as when the person to be searched takes off a coat or a hat, the similarity may be determined to be low. If this happens, the movement path of the person to be searched will be interrupted, making it difficult to track the person to be searched.

An objective of the present disclosure is to provide a technique that suppresses the tracking from being interrupted when the appearance of the moving body changes during the tracking of the moving body reflected in each video data acquired by a plurality of cameras.

### SUMMARY

An aspect of the present disclosure is a tracking system for a moving body and has the following features.

The tracking system includes a memory device and a processor. The memory device stores each video data acquired by at least two cameras. The processor is configured to processing to generate a graph consisting of at least two nodes and at least one edge indicating a relationship between the at least two nodes, based on each video data, and to perform processing to search a tracking target by referring to the graph with a query including an image of the tracking target as its input.

In the graph, a node representing a single camera included in the at least two cameras and a node representing a tracking identification number assigned to a moving body reflected in image data acquired by the single camera are connected via at least one edge. The tracking identification number includes a common tracking identification number assigned to the same moving object reflected in the image data acquired by the single camera.

In the graph, nodes representing respective single cameras are connected via at least one edge representing a relationship between the at least two single cameras if there is a relationship between the at least two single cameras.

In the graph, nodes representing the at least two common tracking identification numbers are connected via at least one edge representing that the at least two moving bodies reflected in each video data captured by the at least two single cameras are the same moving object if the nodes representing the at least two common tracking identification numbers are recognized to be the same moving object.

In the graph, a node representing the common tracking identification number and a node representing an image of the same moving object to which the common tracking identification number is assigned are connected via at least one edge.

In the processing to search for the tracking target, the processor is configured to:
extract a feature quantity of the tracking target from the image of the tracking target;
among the moving body feature quantities extracted from at least two moving body images represented by the at least two nodes constituting the graph, specify the moving body having the feature quantity that is most similar to the tracking target feature quantity; and
specify a tracking target graph indicating the graph including a node representing the tracking identification number assigned to the specified moving body and at least one node connected to the node representing the tracking identification number via at least one edge.

According to present disclosure, the processing to generate the graph composed of at least two nodes and at least one edge indicating a relationship between the at least two nodes. In this graph, the node representing the single camera and the node representing the tracking identification number assigned to the moving body reflected in image data acquired by the single camera are connected via at least one edge. This tracking identification number includes a common tracking identification number assigned to the same moving object reflected in the image data acquired by the single camera.

In this graph, the nodes representing respective single cameras are connected via at least one edge representing the relationship between the at least two single cameras if there is the relationship between the at least two single cameras. In the graph, further, the nodes representing the at least two common tracking identification number are connected via at least one edge representing that the at least two moving bodies reflected in each video data captured by the at least two single cameras are the same moving object if the nodes representing the at least two common tracking identification number are recognized to be the same moving object. In the graph, furthermore, the node representing the common tracking identification number and the node representing then image of the same moving object to which the common tracking identification number is assigned are connected via at least one edge.

In this way, according to the processing to generate the graph, it is possible to generate the graph in which the nodes representing the tracking identification numbers before and after the appearance of the moving body changes are connected.

According to the present disclosure, processing to search for the tracking target is also performed. In this processing, the feature quantity of the tracking target is extracted from the image of the tracking target included in the query. Also, among the moving body feature quantities extracted from at least two moving body images represented by at least two nodes constituting the graph, the moving body having the feature quantity that is most similar to the tracking target feature quantity is specified. In addition, tracking target graph indicating the graph including the node representing the tracking identification number assigned to the specified moving body and at least one node connected to the node representing the tracking identification number via at least one edge is specified.

A moving body with a feature quantity most similar to that of the tracking target is likely to be the tracking target. In this regard, according to the processing to search for the tracking target, it is possible to specify the moving body whose appearance has the most similar feature quantity to the appearance before or after the change, and specify the tracking target graph including the node representing the tracking identification number of this specified moving body. Therefore, according to the present disclosure, during the tracking the moving body reflected in each video data acquired by a plurality of cameras, it is possible to prevent the tracking from being interrupted when the appearance of this moving body changes.

### BRIEF DESCRIPTION OF DRAWINGS

FIG. 1 is a diagram for illustrating an example overall configuration of a tracking system related to an embodiment;

FIG. 2 is a diagram for illustrating detection processing of a person and re-identification processing of the person performed by a graph generation processing portion;

FIG. 3 is a diagram showing a basic configuration example of a graph generated by the graph generation processing portion;

FIG. 4 is a diagram showing a detailed configuration example of the graph generated by the graph generation processing portion;

FIG. 5 is a diagram for illustrating an example of processing performed by a search processing portion;

FIG. 6 is a diagram for illustrating root nodes and leaf nodes; and

FIG. 7 is a diagram for illustrating an example of processing performed by a graph arrangement processing portion.

### DESCRIPTION OF EMBODIMENT

An embodiment of the present disclosure will be described below with reference to the drawings. In each Figure, the same or corresponding parts are given the same sign and the explanation thereof will be simplified or omitted.

### 1. Overall Configuration Example

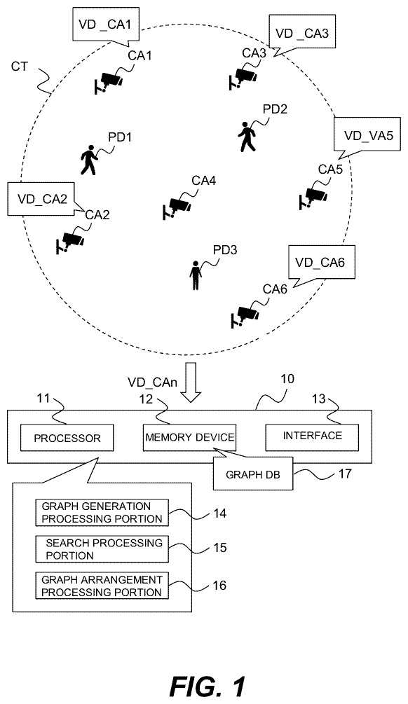

FIG. 1 is a diagram for illustrating an example overall configuration of a tracking system (hereinafter also simply referred to as a “system”) related to embodiment. The system related to the embodiment is a system for tracking a moving body moving inside an urban CT. There is no limit to the scale of the city CT in this disclosure. A so-called smart city is an example of a large-scale urban CT, an underground mall is an example of a medium-sized urban CT, and a large building is an example of a small-scale urban CT. Examples of moving bodies include persons, robots, and vehicles. In embodiment, the moving body is a person (a pedestrian PD). Walkers PD1-PD3 are depicted in FIG. 1 as an example of the pedestrian PD.

The system according to embodiment includes at least two cameras placed in the city CT. FIG. 1 depicts cameras CA1-CA6 as an example of at least two cameras. The camera CA1 acquires image data VD_CA1. Similar to the camera CA1, the cameras CA2-CA6 obtain image data VD_CA2-VD_CA6, respectively. Image data VD_CAn of any one camera CAn (n is a natural number) placed in the city CT is transmitted to the management server 10 via the communication line network. Note that the communication line network is not particularly limited, and wired and wireless networks can be used.

The management server 10 is a computer including at least one processor 11, at least one memory device 12, and at least one interface 13. The processor 11 performs various data processing. The processor 11 includes a CPU (Central Processing Unit). The memory device 12 stores various data necessary for data processing. Examples of the memory device 12 include an HDD, an SSD, a volatile memory, and a nonvolatile memory. The interface 13 receives various data from the outside and also outputs various data to the outside. The various data that the interface 13 receives from the outside includes the image data VD_CAn. This image data VD_CAn is stored in the memory device 12. A graph DB (database) 17 is formed in the memory device 12. The graph DB 17 may be formed in an external device that can communicate with the management server 10.

### 2. Configuration Example of Management Server

FIG. 1 shows an example function configuration of the management server 10. In the example shown in FIG. 1, the management server 10 includes a graph generation processing portion 14, a search processing portion 15, and a graph arrangement processing portion 16. Note that these functions are realized by the processor 11 executing various programs stored in the memory device 12.

### 2-1. Graph Generation Processing Portion

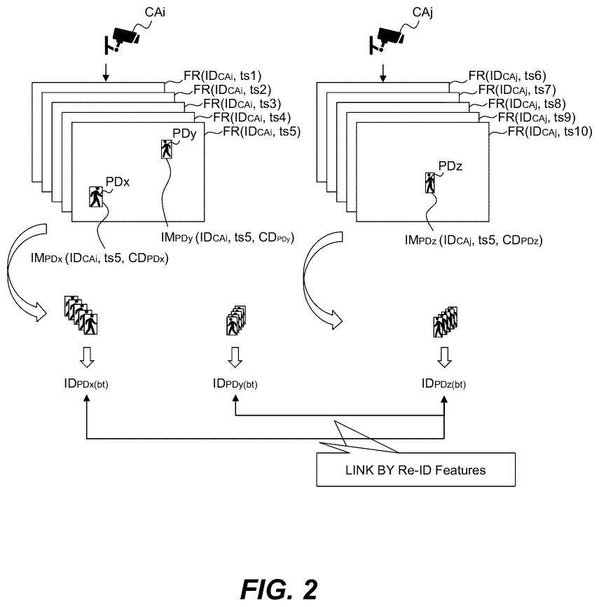

The graph generation processing portion 14 performs processing to generate a graph GPH based on the image data VD_CAn. To generate the graph GPH, the graph generation portion processing 14 performs person detection and extraction processing and person re-identification processing. FIG. 2 is a diagram for illustrating person detection processing and person re-identification processing performed by the graph generation processing portion 14.

FIG. 2 depicts image data VD_CAi of a camera CAi and image data VD_CAj of a camera CAj as examples of image data VD_CAn. The image data VD_CAi and VD_CAj are each separated by a predetermined time width, and FIG. 2 depicts a set of frames FR at interval time bt. Each frame FR of image data VD_CAi includes, for example, data of IDCAi of the camera CAi and data of time stamp ts (frame acquisition time). Like each frame FR of image data VD_CAi, each frame FR of image data VD_CAj also includes data of IDCAj of the camera CAj and the data of time stamp ts.

In the detection and extraction processing, first, a frame FR in which a person is detected is extracted. Subsequently, the detected person is extracted from this extracted frame. In the example shown in FIG. 2, the pedestrians PDx and PDy are detected in each frame within interval time bt1 (time stamps ts1-ts5) of the image data VD_CAi. Furthermore, the pedestrian PDz is detected in each frame within interval time bt2 (time stamps ts6-ts10) of the image data VD_CAj. Bounding boxes surrounding these pedestrian PDs are assigned to each position where pedestrians PDx, PDy, and PDz are detected. By trimming this bounding box, images IM_{PDx}, IM_{PDy}, and IM_{PDz} of pedestrians PDx, PDy, and PDz are extracted, respectively. The images IM_{PDx} and IM_{PDy} of pedestrian PDs include, for example, data of ID_{CAi} of camera CAi, data of time stamp ts, and data of coordinate CD_{PD} in frame FR of the extracted image.

In re-identification processing, feature quantities for re-identification processing (hereinafter also referred to as “Re-ID feature quantities”) are extracted from each image IM_{PD} extracted in detection and extraction processing. Extraction of Re-ID feature quantity is performed using Re-ID model based on machine learning. Note that the technique for extracting Re-ID feature quantities using the Re-ID model is well known, and the technique is not particularly limited. Once the Re-ID feature quantity is extracted from each image IM_{PD}, it is determined whether the person included in the image sequence is the same person by comparing the Re-ID feature quantities.

In the example shown in FIG. 2, the Re-ID feature quantities of persons extracted from each image IM_{PD} in interval time bt1 are similar, so pedestrians PDx and PDy included in the image sequence in interval time bt1 are Each person is determined to be the same person. In addition, since the Re-ID feature quantities of the persons extracted from each image IM_{PD} in interval time bt2 are similar, it is determined that the pedestrian PDz included in the image sequence in interval time bt2 is the same person.

When detection processing is performed, a tracking ID_{PD} is assigned to the person reflected in the image data VD_CAn. Among these, a person who is determined to be the same person through re-identification processing is given a tracking ID_{PD} common to this person (hereinafter also referred to as a “common tracking ID_{PD}”). The common tracking ID_{PD} is also referred to as universal unique ID (UUID). In the example shown in FIG. 2, common tracking ID_{PDx(bt1)}, ID_{PDy(bt1)}, and ID_{PDz(bt2)} are assigned to the pedestrians PDx, PDy, and PDz. Each common tracking ID_{PD} combines data of interval time bt with data representing the data of Re-ID feature quantity extracted from the image sequence of this interval time bt. Note that the example of selecting representative data of Re-ID feature quantity is not particularly limited, and any method can be adopted.

The common tracking ID_{PD} is generated every interval time bt. Therefore, if the same pedestrian PD continues to be captured by a single camera, the common tracking ID_{PD} assigned to this pedestrian PD may be generated separately by the number of interval times bt. Therefore, in re-identification processing, Re-ID feature quantity may be compared between a plurality of different image sequences at interval time bt. For example, Re-ID feature quantity is compared between two image sequences of interval time bt with close time stamps ts. Then, if the Re-ID feature quantity is similar between multiple image sequences, it is determined that each pedestrian PD included in these image sequences is the same person, and the Re-ID feature quantity is assigned to each pedestrian PD separately. The common tracking ID_{PD}s that were previously used may be integrated into one.

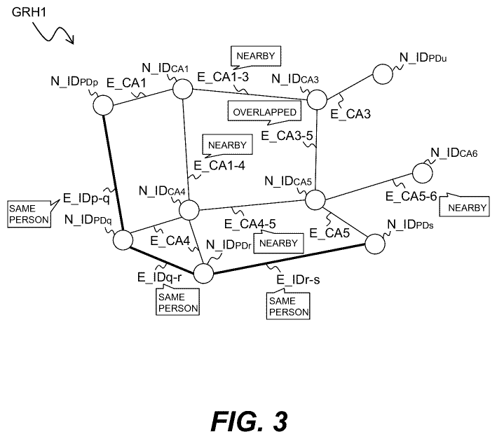

The graph generation processing portion 14 generates a graph GRH based on the common tracking ID_{PD} given to the pedestrian PD by the above-described re-identification processing and each ID of at least two cameras placed in the city CT. The generated graph GRH is stored in the graph DB 17. As already explained, the graph GRH is expressed using nodes (vertexes, node points) and edges (edges, branches) in graph theory. FIG. 3 is a diagram showing a basic configuration example of the graph GRH generated by the graph generation processing portion 14. FIG. 3 is a graph that includes nodes N_ID_{CA1}-N_ID_{CA6} representing each ID of cameras CA1-CA6 (however, CA2 is omitted) shown in FIG. 1, and edge E representing the relationship between these nodes. GRH1 is depicted.

Here, the installation position of camera CA is close to that of camera CA3. Therefore, there is a relationship between these cameras. Therefore, in the graph GRH1 shown in FIG. 3, node N_ID_{CA1} representing the ID of camera CA1 and node N_ID_{CA3} representing the ID of camera CA3 are connected via edge E_CA1-3. The meaning of this edge E_CA1-3 is “nearby”. “NEARBY” relationships also exist between camera CA1 and camera CA4, between camera CA4 and camera CA5, and between camera CA5 and camera CA6. Therefore, node N representing each ID of two cameras CA having a relationship is connected by one edge E (edge E_CA1-4, edge E_CA4-5, and edge E_CA5-6).

Another example of a relationship between two cameras CA is that some or all of the imaging ranges of these cameras overlap. Here, part of the imaging range of camera CA3 and that of camera CA5 overlap. Therefore, in the graph GRH1 shown in FIG. 3, node N_ID_{CA3} representing the ID of camera CA3 and node N_ID_{CA5} representing the ID of camera CA5 are connected via edge E_CA3-5. The meaning of this edge E_CA3-5 is “overlap (OVERLAPPED)”.

The node N_ID_{PD} representing the common tracking ID_{PD} assigned to the pedestrian PD is connected via at least one edge E to the node N_ID_{CAn} representing the camera CAn that acquired the image data VD_CAn from which this common tracking ID_{PD} was assigned. tied together. FIG. 3 depicts nodes N_ID_{PDq}, N_ID_{PDq}, N_ID_{PDr}, N_ID_{PDs}, and N_ID_{PDu}, which represent common tracking ID_{PD}s assigned to pedestrians PDq, PDq, PDr, PDs, and PDu, respectively. Node N_ID_{PDq} is connected to node N_ID_{CA1} via edge E_CA1. Nodes N_ID_{PDq} and N_ID_{PDr} are each connected to node N_IDCA4 via two edges E_CA4. Node N_ID_{PDs} is connected to node N_ID_{CA5} via edge E_CA5, and node N_ID_{PDu} is connected to node N_ID_{CA3} via edge E_CA3.

As already explained, the common tracking ID_{PD} includes a combination of interval time bt data and representative data of Re-ID feature quantity in the image sequence. In the embodiment, re-identification processing of the person seen in at least two cameras is performed using representative data of the Re-ID feature quantity. In this re-identification processing, the same processing as the comparison of Re-ID feature quantity performed between a plurality of different image sequences at interval time bt is performed. However, while the comparison of Re-ID feature quantity between multiple image sequences targets one camera, the comparison of representative data of Re-ID feature quantity targets two cameras. It is done as. If the representative data of the Re-ID feature quantity is similar between the two cameras, it is determined that the pedestrian PDs separately seen by these cameras are the same person.

In the graph generation processing portion 14, when it is determined that the pedestrian PDs separately seen by two cameras are the same person, the node N_ID_{PD} representing the common tracking ID_{PD} separately assigned to these pedestrian PDs is Tie through edge E. In the graph GRH1 shown in FIG. 3, pedestrians PDq and PDq are determined to be the same person, and pedestrians PDr and PDs are determined to be the same person. Therefore, node N_ID_{PDq} and node N_ID_{PDq} are connected via edge E_IDp-q, and node N_ID_{PDr} and node N_ID_{PDs} are connected via edge E_IDr-s. The meaning of edge E_IDp-q and E_IDr-s is “same person”.

In the graph GRH1 shown in FIG. 3, it is also determined that pedestrians PDq and PDr are the same person. This determination is based on the results of a comparison of Re-ID feature quantity between a plurality of image sequences that differ in interval time bt, which is performed for one camera. For this reason, node N_ID_{PDq} and node N_ID_{PDr} are connected via edge E_IDq-r, which means “same person”.

As a result of comparing Re-ID feature quantity, even if it is determined that the pedestrian PDs separately seen by two cameras are not the same person, when the predetermined movement condition is met, the pedestrian PDs are Node N_ID_{PD} representing separately assigned common tracking ID_{PD} may be connected via edge E_ID meaning “same person”. The predetermined movement condition includes, for example, the following conditions (i) to (iii).
(i) The similarity of Re-ID feature quantity is greater than or equal to the reference value.
(ii) The interval between the timestamps ts of the additional information ADD (image IM_{PD}) of each of the two nodes N_ID_{PD} is within a predetermined time.
(iii) The distance between the installation positions of the two cameras CA connected to the two nodes N_ID_{PD} in condition (i) is within the predetermined distance.

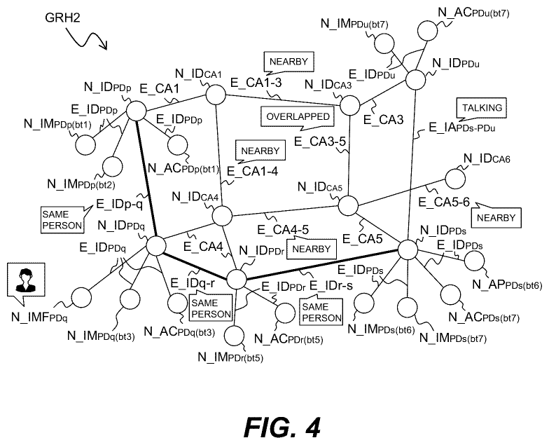

FIG. 4 is a diagram showing a detailed configuration example of a graph generated by the graph generation processing portion 14. In graph GRH2 shown in FIG. 4, node N representing additional information ADD is added to graph GRH1 shown in FIG. 3. This additional information ADD is for the pedestrian PD to which the common tracking ID_{PD} is assigned. Examples of additional information ADD include image IM_{PD} of the pedestrian PD, appearance feature AP_{PD} of the pedestrian PD, action AC_{PD} of the pedestrian PD, face image IMF_{PD} of the pedestrian PD, and the like.

The image IM_{PD} of the pedestrian PD was used to extract Re-ID feature quantity. Examples of the pedestrian PD's appearance features include the pedestrian PD's color, clothing, and body shape. This appearance feature is estimated using a previously learned appearance model. In addition to “walking”, examples of the pedestrian PD's action include “carry” and “opening” performed by the pedestrian PD on a stationary body such as a baggage. This action is estimated using an action model learned in advance. This action also includes interaction actions such as “talking”, and “delivery” performed by multiple persons together. The face image IMF_{PD} of the pedestrian PD may be a face image obtained by trimming the face part from the image IM_{PD} of the pedestrian PD, or may be a face image provided externally in search processing by search processing portion 15 (described later).

In the graph GRH2 shown in FIG. 4, beyond the three edges E_ID_{PDq} extending from node N_ID_{PDq}, nodes N_IM_{PDq(bt1)} and N_IM_{PDq(bt2)} representing the image IM_{PDq} of a pedestrian PDq, and node N_AC_{PDq(bt1)} representing the action of the pedestrian PDq are located. In addition, beyond the three edges E_ID_{PDq} extending from node N_ID_{PDq}, node N_IMF_{PDq} representing face image IMF_{PDq} of the pedestrian PDq, node N_IM_{PDq(bt3)} representing image IM_{PDq} of the pedestrian PDq, and node N_AC_{PDq(bt3)} representing action of the pedestrian PDq are located.

Although a detailed explanation will be omitted, in graph GRH2, node N representing additional information ADD for each pedestrian PD is connected to node N_ID_{PD} via edge E for nodes N_ID_{PDr}, N_ID_{PDs}, and N_ID_{PDu}. Note that node N_ID_{PDs} and node N_ID_{PDu} are connected via edge E_IA_{PDs-PDu}, which means interaction action “talking”. Further, node N_AP_{PDs(bt6)} connected to node N_ID_{PDs} via edge E_ID_{PDs} represents appearance feature AP_{PD}s of pedestrian PDs at interval time bt6.

### 2-2. Search Processing Portion

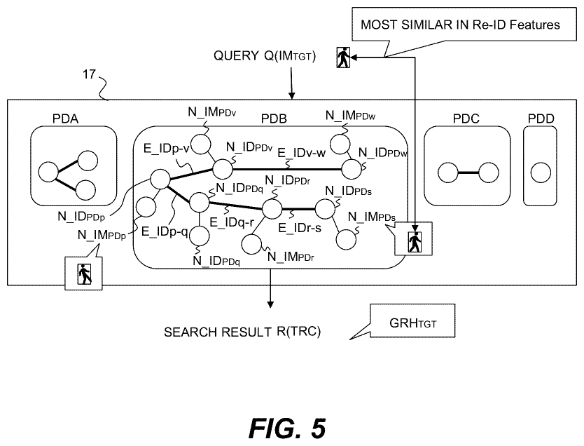

The search processing portion 15 performs a process of searching for a tracking target using the graph GPH stored in the graph DB 17. FIG. 5 is a diagram for illustrating an example of search processing performed by search processing portion 15. In the example shown in FIG. 5, the graph DB 17 is referenced using the image IM_{TGT} of the tracking target as the query Q (input information). The image IM_{TGT} is selected, for example, from the frames of the pedestrian PD used to extract the Re-ID feature quantity. The image IM_{TGT} may be provided from outside the tracking system. The image IM_{TGT} may be the face image IMF_{TGT} of the tracking target. For example, the face image IM_{TGT} is trimmed from the frame of the pedestrian PD used to extract the Re-ID feature quantity. The face image IMF_{TGT} may be provided from outside the tracking system.

In the example shown in FIG. 5, the image IM_{PD} of the pedestrian PD having the most similar Re-ID feature quantity to the Re-ID feature quantity extracted from the image IM_{TGT} (i.e., the Re-ID feature quantity with the highest similarity) is searched. In this search, the Re-ID feature quantity extracted from the image IM_{TGT}, and the Re-ID feature quantity extracted from the image IM_{PD} of the pedestrian PD represented by the node N_IM_{PD} connected to the node N_ID_{PD} representing the common tracking ID_{PD} are compared. For the Re-ID feature quantity extracted from the image IM_{PD} of the pedestrian PD, for example, representative data of the Re-ID feature quantity selected at the time of assigning the common tracking ID_{PD} is used.

FIG. 5 includes node N_ID_{PD} that represents each common tracking ID_{PD} of pedestrian PDA, PDB, PDC, and PDD, and node N_IM_{PD} that represents the image IM_{PD} of these pedestrians connected to each node N_ID_{PD} via edge E_ID_{PD}. A graph is drawn. The graph of pedestrian PDB is a part of graph GRH2 explained in FIG. 4.

In the example shown in FIG. 5, it is determined that the Re-ID feature quantity extracted from the images IMPDs of pedestrian PDs has the highest similarity. Therefore, in this example, pedestrian PDs are identified as the person most likely to be the tracking target. When pedestrian PDs are identified as the person who is most likely to be the tracking target, edge E_ID, which means “same person (SAME PERSON)”, is added to node N_ID_{PD}s, which represents the common tracking ID_{PD} assigned to pedestrian PDs. A group of nodes N_ID_{PD} (nodes of node N_ID_{PD} of the pedestrian PDB) connected through the pedestrian PDB is specified.

In the example shown in FIG. 5, node N_ID_{PDs} is connected to node N_ID_{PDr} through edge E_IDr-s, and node N_ID_{PDr} is connected to node N_ID_{PDq} through edge E_IDq-r. Also, node N_ID_{PDq} is connected to node N_ID_{PDq} and edge E_IDp-q, node N_ID_{PDq} is connected to node N_ID_{PDv} and edge E_IDp-v, and node N_ID_{PDv} is connected to node N_ID_{PDw} and edge E_IDv-w. These edge E_IDs all mean “same person”.

Therefore, even if the Re-ID feature quantity extracted from the image IM_{PDq} of pedestrian PDq is not similar to the Re-ID feature quantity extracted from the image IM_{TGT}, the person who is most likely to be the tracking target by specifying the pedestrian PDs, it becomes possible to obtain the tracking target graph (tracking target graph) GRH_{TGT} as the search result R (TRC).

In the example shown in FIG. 5, the graph DB 17 is referenced using the tracking target image IM_{TGT} as the query Q (input information). However, in addition to the tracking target image IM_{TGT}, information such as date and time, location, etc. may be added to the query Q. Further, in the example shown in FIG. 5, a graph GRH_{TGT} including node N_ID_{PD} representing the common tracking ID_{PD} of the tracking target and node N_IM_{PD} representing the image IM_{PD} of the tracking target is output as the search result R (TRC). However, node N_ID_{CA} representing the camera CAn described in FIG. 3 and node N representing additional information ADD other than the image IM_{PD} described in FIG. 4 may be included in the graph GRH_{TGT} of the tracking target.

Another example of search processing for a tracking target is to narrow down the node N_ID_{PD} representing the common tracking ID_{PD}. By narrowing down the node N_ID_{PD}, it is expected that the processing load of the search by the processor 11 will be reduced. Narrowing down of node N_ID_{PD} is performed according to predetermined narrowing conditions. The predetermined narrowing conditions include, for example, at least one of the following conditions (i) and (ii).
(i) Must be a node N_ID_{PD} that corresponds to root node or leaf node
(ii) Must be a node N_ID_{PD} with a connection order of a predetermined degree or higher

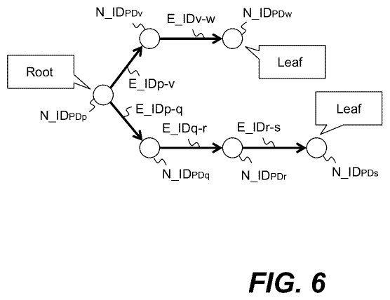

Regarding condition (i), FIG. 6 is a diagram for illustrating the root node and leaf node. FIG. 6 depicts a graph including nodes N_ID_{PDq}, N_ID_{PDq}, N_ID_{PDr}, N_ID_{PDs}, N_ID_{PDv}, and N_ID_{PDw}. This graph is part of the pedestrian PDB graph explained in FIG. 5. However, in the example shown in FIG. 6, the edge E_ID connecting two adjacent nodes N_ID_{PD} is drawn with an arrow. The direction of this arrow means the predicted movement direction of the pedestrian PDB based on the interval time bt (or timestamp ts).

The root node is a node N_ID_{PD} that corresponds to the “root” of the nodes N_ID_{PD} included in the graph of the pedestrian PDB (i.e., the nodes of node N_ID_{PD} of the pedestrian PDB). In the example shown in FIG. 6, node N_ID_{PDq} corresponds to the root node. The root node is, for example, the oldest node N_ID_{PD} among the nodes. Typically, the root node is the node N_ID_{PD} in which the data of the timestamp ts (or the data of the interval time bt) held by the node N_IM_{PD} connected to the node N_ID_{PD} is the oldest. When date and time information is included in the query Q, the oldest node N_ID_{PD} within this date and time range is the root node.

The leaf node is a node N_ID_{PD} corresponding to “leaf” among the nodes N_ID_{PD} included in the graph of the pedestrian PDB (i.e., the nodes of the node N_ID_{PD} of the pedestrian PDB). The leaf node is, for example, the newest node N_ID_{PD} among the nodes. Typically, a leaf node is a node N_ID_{PD} whose data with a timestamp ts (or data with an interval time bt) owned by a node N_IM_{PD} connected to the node N_ID_{PD} is the newest. The leaf node does not have to be the newest node N_ID_{PD}. Among the nodes of node N_ID_{PD} other than the root node, node N_ID_{PD} located at the end of node N_ID_{PD} may correspond to a leaf node. Therefore, in the example shown in FIG. 6, nodes N_ID_{PDs} and N_ID_{PDr} correspond to leaf nodes.

Regarding condition (ii), the “connection order” of node N_ID_{PD} means the total number of nodes N_ID_{PD} that constitute the nodes. A large total number of nodes N_ID_{PD} forming a node means that the connection order is high. By focusing only on node N_ID_{PD} with a high connection order, it is expected that the processing load of the search by the processor 11 will be reduced. Focusing only on node N_ID_{PD} with a high connection order is because node N_ID_{PD} with a low connection order can be excluded from the search target as noise data.

### 2-3. Graph Arrangement Processing Portion

The graph arrangement processing portion 16 performs processing to arrangement of the graph GPH generated by the graph generation portion processing 14. The graph arrangement processing portion 16 specifically performs re-connection of edge E_ID, which means “same person”. As already explained, the edge E_ID meaning “same person” connects the node N_ID_{PD} representing the common tracking ID_{PD} of the pedestrian PD with similar Re-ID feature quantity. However, time information is not added to node N_ID_{PD} connected by this edge E_ID. Therefore, although it is possible to roughly track the tracking target from the graph (tracking target graph) GRH_{TGT} explained in FIG. 5, it is difficult to grasp the movement direction of the tracking target.

Therefore, re-connection of edge E_ID, which means “same person”, is performed. This re-connection of edge E_ID is performed periodically independent of the generation processing of graph GRH. The re-connection of edge E_ID is performed based on the data of time stamp ts (or data of interval time bt) possessed by node N_IMPD connected to node N_ID_{PD}.

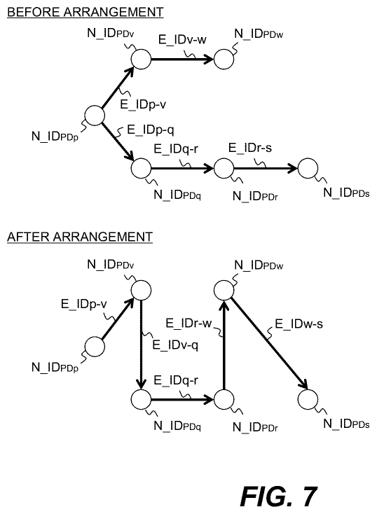

FIG. 7 is a diagram for illustrating an example of processing performed by graph arrangement processing portion 16. FIG. 7 shows the pedestrian PDB graph explained in FIG. 6. The upper part of FIG. 7 is an example of a graph before arrangement processing (before re-connection). As can be understood from the upper part of FIG. 7, before arrangement processing, node N_ID_{PDq} representing common tracking ID_{PD} is branched and connected to nodes N_ID_{PDq} and N_ID_{PDv}. Such a connection is determined that the Re-ID feature quantity is similar between node N_ID_{PDq} and node N_ID_{PDq} and between node N_ID_{PDq} and node N_ID_{PDv}, while the feature quantity is similar between node N_ID_{PDq} and node N_ID_{PDr}. This can occur when it is determined that they are not similar.

The lower part of FIG. 7 is an example of a graph after arrangement processing (after re-connection). As can be seen from the bottom of FIG. 7, by performing arrangement processing, the edge E_ID of the node N_ID representing the common tracking ID_{PD} linked as the same person can be connected in chronological order. Therefore, in the search processing using the graph GRH after the arrangement processing, it becomes possible to output the graph GRH_{TGT} including information on the movement direction of the tracking target as the search result R (TRC). This contributes to improving the convenience of the search result R (TRC).

What is claimed is:

1. A tracking system for a moving body, comprising:
a memory device in which video data acquired by at least two cameras is stored; and
a processor,
wherein, the processor is configured to perform:
processing to generate a graph consisting of at least two nodes and at least one edge indicating a relationship between the at least two nodes, based on each video data;
processing to search a tracking target by referring to the graph with a query including an image of the tracking target as its input,
wherein, in the graph, a node representing a single camera included in the at least two cameras and a node representing a tracking identification number assigned to a moving body reflected in image data acquired by the single camera are connected via at least one edge,
wherein, the tracking identification number includes a common tracking identification number assigned to the same moving object reflected in the image data acquired by the single camera,
wherein, in the graph, the nodes representing respective single cameras are connected via at least one edge representing a relationship between the at least two single cameras if there is a relationship between the at least two single cameras,
wherein, in the graph, nodes representing the at least two common tracking identification numbers are connected via at least one edge representing that the at least two moving bodies reflected in each video data captured by the at least two single cameras are the same moving object if the nodes representing the at least two common tracking identification numbers are recognized to be the same moving object,
wherein, in the graph, a node representing the common tracking identification number and a node representing an image of the same moving object to which the common tracking identification number is assigned are connected via at least one edge,
wherein, in the processing to search for the tracking target, the processor is configured to:
extract a feature quantity of the tracking target from the image of the tracking target;
among the moving body feature quantities extracted from at least two moving body images represented by the at least two nodes constituting the graph, specify the moving body having the feature quantity that is most similar to the tracking target feature quantity; and
specify a tracking target graph indicating the graph including a node representing the tracking identification number assigned to the specified moving body and at least one node connected to the node representing the tracking identification number via at least one edge.

2. The tracking system according to claim 1,
wherein, in the processing to search for the tracking target, the processor is configured to:
before extracting the feature quantities of the moving bodies from the at least two moving body images, select at least two nodes from the at least two nodes consisting of the graph according to a predetermined narrowing condition; and
extract respective feature quantities of the at least two moving bodies from the at least two moving body images represented by the at least two selected nodes.

3. The tracking system according to claim 1,
wherein, in the processing to generate the graph, the processor is configured to:
determine whether the at least two moving bodies are the same moving object based on the feature quantities of these moving bodies that are extracted from respective images of the at least two moving bodies, wherein the respective images of the at least two moving bodies are assigned to respective nodes representing the tracking identification numbers and are connected via at least one edge; and
when it is determined that the at least two moving bodies are similar, link the nodes representing the common tracking identification numbers assigned to the at least two moving bodies by at least one node representing that these moving bodies are the same moving object.

4. The tracking system according to claim 3,
wherein, in the processing to generate the graph, the processor is further configured to:
when it is determined that the at least two mobbing bodies are not similar in the determination based on the respective images of these moving bodies, determine whether a predetermined movement condition for the at least two moving bodies is satisfied; and
when it is determined that the predetermined movement condition for the at least two moving bodies is satisfied, link the nodes representing the common tracking identification numbers assigned to the at least two moving bodies by at least one node representing that these moving bodies are the same moving object.

5. The tracking system according to claim 3,
wherein the processor is further configured to perform processing to arrange the graph generated by the processing to generate the graph,
wherein, in the processing to arrange the graph, the processor is configured to:
extract nodes having at least three connections of the nodes representing the common tracking identification number respectively assigned to the at least two moving bodies; and
relink at least one edge connecting the nodes constituting the nodes based on timestamp data for the respective images of at least three moving objects connected to the nodes constituting the nodes via at least one edge.
